(19) United States
(12) Patent Application Publication
(10) Pub. No.: US 2005/0246571 A1
(43) Pub. Date: Nov. 3, 2005

(54) Method for processing instructions

(76) Inventor: Helge Betzinger, Dresden (DE)

Correspondence Address: BAKER & BOTTS, 30 ROCKEFELLER PLAZA, NEW YORK, NY, 10112, US

(21) Appl. No.: 10/502,991

(22) PCT Filed: Jan. 17, 2003
(86) PCT No.: PCT/DE03/00126

§ 371 Date: May 31, 2005

(30) Foreign Application Priority Data
Feb. 1, 2002 (DE) 102 04 345.0

(51) Int. Cl. G06F 11/00

(52) U.S. Cl. 714/5

(57) ABSTRACT

The invention relates to a method for executing instructions in a processor, according to which an instruction to be executed of a program memory is addressed by a program control unit by means of a program counter reading of a program counter that operates in said unit. The addressed instruction is then read out, decoded and executed by the program control unit. The method extends EPIC processor technology by the rapid execution of instruction blocks, thus accelerating the instruction execution, without having to call up subroutines. To achieve this, the program control unit additionally stores the current program counter reading and the number of successive instructions when a jump instruction occurs in the form of a block instruction, according to which a specific number of instructions are to be executed successively, thus defining the return address after execution. After the last instruction of the instruction block to be executed, the program counter resumes the counting operation from the stored program counter reading.

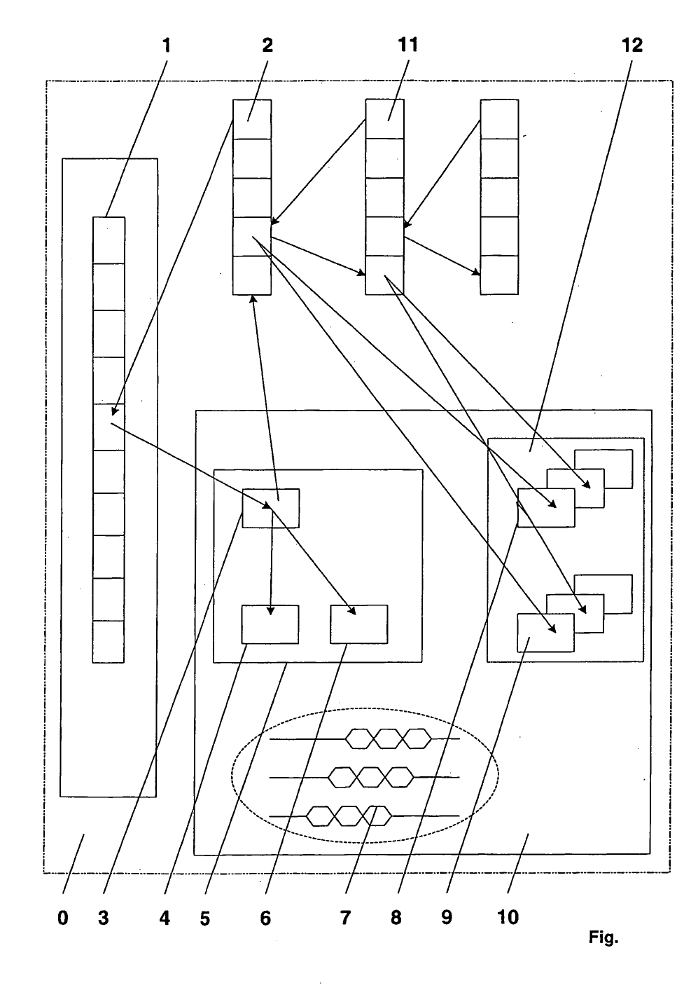

The invention relates to a method of command processing in a processor, in which a program memory command currently to be worked off is addressed by a program control unit, on the one hand, by means of a status of a program counter implemented therein, in that the program control unit preassigns the counting mode and the step width of the program counter and also stores a jump address from which it continues its counting mode upon occurrence of a jump command, and on the other hand the command address is read out, decoded and brought to execution by the program control unit.

The demands for capacity increase of processors have heretofore been met by semiconductor manufacturers through increases in timing frequency, processing breadth and complexity. This line of development encounters physical limits.

Thus further capacity increases are expected from the recognition and use of parallelisms in the course of program processing.

A comprehensive representation of recent lines of development in this regard is given in [in English:] “Computer Architecture, a Quantitative Approach, by John L. Hennessy and David A. Patterson (ISBM 1-55860-329-8). [end English]

Parallelisms here means primarily the operation and calculation of processes independent of each other, capable of being carried out parallelwise in a processor.

This line of development in processors is also known by the term instruction-level parallelism (ILP). ILP arises through a combination of processor and compiler techniques which enhance speed of execution, in that RISC-like operations are carried out in parallel.

ILP-based systems use firstly conventional high-level programming languages created for sequential processors, and secondly compiler technology and hardware to recognize contained parallelisms automatically. In the programmatic use of ILP-based systems, however, it is to be observed that program branchings are in principle not parallelizable.

In the prior art, there are known super-scalar processors. In these, ILP processors for sequential command streams are realized. Here, the program contains no information about available parallelisms. This must be discovered by the hardware. That is the reason why such processors call for a constantly increasing complexity of the hardware, where the complexity increases more than proportionally with increasing demands on the performance of the processors.

In the prior art, very-long-instruction-word (VLIW) processors are known as well. In these, the program contains the information on existing parallelisms. A disadvantage of this processor technology is the circumstance that the prospective command processes of program branchings, branch prediction and speculative code execution are not available.

On the other hand, explicitly parallel instruction computing (EPIC) processor technology—as a further development—combines the advantages of the aforementioned two lines of development. Here, the maximum of complexity is shifted from the hardware into the compilers, that is, the software.

An EPIC program, besides the ILP, tells the processor in addition under what conditions certain instructions are to be carried out. The processor will execute all commands, but take over only those results which meet the additional conditions (predicated instruction).

In this technology also, the disadvantage remains that the command processing of fixed blocks of commands can be realized only by sub-programs involving great command outlay. Also, here an optimal conformation of the prediction of program branches in which the backjump address is already fixed is not possible.

This disadvantage makes itself felt in performance losses especially if such command blocks occur frequently in the programs.

Likewise, there will be no time-saving consideration of commands to be worked off that are to be processed just in the delayed slots of the program control.

A software method of processing program branchings with economy of time, known in the prior art, consists in saving the jumps to and from the sub-programs called up by so programming the instructions that they can be executed “in line.” But this requires that the sub-programs (UP) be copied complete into the program area where the functional call itself occurs. This multiple occurrence of the UPs in the program here involves the disadvantage of high memory outlay.

Thus, there is the problem of enlarging the EPIC processor technology with possibilities for rapid command execution of blocks of commands, going beyond the usual call-up of sub-programs.

The solution of the problem according to the invention provides that on the hardware side, an additional block command is implemented into the processors, so that the program control unit upon occurrence of a program branching in which a certain number of commands to be worked off successively are provided, and so the backjump address is fixed after command processing, alternatively instead of calling up a sub-program of this implemented block command in which, additionally, a storage of the current program counter status and a storage of the number of successive commands are performed.

After the last command of the block to be worked off, the command block is again continued at the stored status of the counting operation of the program counter.

A further conformation of the solution of the problem according to the invention provides that the additional block command be executed as a conditional command (predicated instruction) by the computer, the command word containing the information under what condition the stored number of commands of the block are worked off.

Thus, it is realized that the special block command is also executed as a conditional command.

In an advantageous solution of the problem, according to the invention, adapted to the EPIC processor technology, it is provided that at a program branching triggered by a conditional block command, both branches are executed in a preliminary phase until the result of the conditional query has been evaluated at the end of the corresponding delayed slot in an execute phase.

Here, after rejection of an alternative branch not satisfying this condition, the command processing is immediately continued in the advanced position of the now valid execute phase of the other branch.

Since the commands predominantly are read out, decoded and executed only during several machine cycles, the delayed slots serve for each command being so processed as current execute channels in the program control area. They are closed only after the execute phase of each command.

Therefore, command processing time can be saved in that an execute phase of a preceding command need not necessarily be reached before the next command can be read out.

But a consequence of this is that for some machine cycles overlappingly, the commands in course of processing are worked off in the delayed slots.

For application of the block command according to the invention, at the end of processing of the commands belonging to the blocks, another time advantage is gained in that, with previously fixed, accurately known backjump point in time, processing of the delayed slots is avoided in that, at the earliest possible point in time, the backjump is initiated at which all delayed slots can remain closed. Such favorable time controls were not possible in the case of a sub-program processing.

In another advantageous embodiment of the solution of the problem according to the invention, provision is made so that in the case of the occurrence of a second block command during the execute phase of a first block command, a required branching is performed in the first command block.

The current processing status of the interruptive first command block and the final address to be stored from the backjump as resulting from the second block command are deposited in a local stack of the program control.

This solution provides that the block commands to be worked off are also performed nested in themselves. Here, it must be ensured that for each block command, the address of the processing status of the preceding interrupted command block and the backjump address resulting from the number of commands of the additional command block of the command to be worked off be deposited in a local stack, and read out again upon backjumping thither. The local stack is located in the program control.

In a solution of the problem according to the invention adapted to the compiler, provision is made so that the addresses of the commands recapitulated in the current command block be deposited in the special address area readable by the compiler.

The invention will now be illustrated in more detail in terms of an embodiment by way of example. The corresponding figure of the drawing shows a schematic representation of the computer with its operations during command processing.

In the figure of the drawings, it may be seen in the program memory 1, the program commands are present in the program sequence. The program counter contained in the program control unit 10 has addressed a command word of the program memory 1, and this has been recognized by a subsequent decoding of the jump command.

Therefore its read-out jump address is deposited in the jump address memory 3. Further, with this jump address the first command block 2 is addressed. Besides, this jump command has been recognized as a block command by the program control unit 10. The result is that in the memory of the current program counter status 4, the present program counter status is deposited.

Furthermore, the number of commands of the block command is likewise deposited in the number-of-commands memory 6. Then the program control unit 10 can compute and preassign the backjump address after the command block has been worked off.

In the figures, it is shown that in the first command block 2, an additional block command is contained.

Corresponding to the usual jump address treatment, the corresponding jump address of this command is deposited in the jump address memory 3, and the 2nd command block 11 is thereby addressed.

Since this command has been recognized as a block command, now also the processing status of the first command block 2 is deposited in the processing status memory of the local stack 9, and the number of commands of the second command block 11 is deposited in the number-of-commands memory of the local stack 8.

After reaching the last command of the second command block 11, similarly to the preassignments from the number-of-commands memory of the local stack 8, there is a jump to the calculated backjump address, and the command processing can be continued to the end in the first command block 2.

Here, the program control unit 10 loads the content of the memory of the current program counter status 4, which represents the processing status of the interrupted program in the program memory 1 by the stored backjump address in the program counter, and there is a backjump to the command of the program memory 1 to be worked off.

Thus, the program can be continued again at the point of interruption in the program memory 1.

### Method of Command Processing

### List of Reference Numerals

0 computer
1 program memory
2 first command block
3 jump address memory
4 memory of current program counter status
5 program counter
6 number-of-commands memory
7 delayed slots (execute phase)
8 number-of-commands memory of local stack
9 processing-status memory of local stack
10 program control unit
11 second command block
12 local stack of program control

1. (canceled)

2. (canceled)

3. (canceled)

4. (canceled)

5. (canceled)

6. Method of executing commands in a processor, where a command to be currently executed from a program memory is addressed by a program control unit, on the one hand, by means of the status of a program counter integrated therein, in that the program control unit preassigns the counting mode and the step width of the program counter and moreover stores a jump address from which the counter, upon occurrence of a jump command, continues its counting mode, and on the other hand the command addressed is read out, decoded and brought to execution by the program control unit, wherein an additional block command is integrated into the processor so that the program control unit, upon occurrence of a program branching, at which a certain number of commands to be executed successively are provided, and hence the backjump address is fixed after the command has been executed, alternatively instead of a sub-program, this implemented block command is called up, for which additionally a storing of the current program counter status and a storing of the number of commands is executed, and in that after the last command of the command block, the counting operation of the program counter is continued at the stored program counter status.

7. Method according to claim 6, wherein the additional block command is executed by the computer as a conditional command where the command word contains the information under what conditions the stored number of commands of the command block are executed.

8. Method according to claim 6 wherein at a program branching triggered by a conditional block command, both branches are executed in a provisional execute phase until the result of the conditional query can be evaluated at the end of the corresponding delayed slot in an execute phase, where, after rejection of an alternative branch not satisfying this condition, the command processing is immediately continued in the advanced position of the now valid execute phase of the other branch.

9. Method according to claim 7, wherein at a program branching triggered by a conditional block command, both branches are executed in a provisional execute phase until the result of the conditional query can be evaluated at the end of the corresponding delayed slot in an execute phase, where, after rejection of an alternative branch not satisfying this condition, the command processing is immediately continued in the advanced position of the now valid execute phase of the other branch.

10. Method according to claim 6, wherein in the event of occurrence of a second block command, additionally to the jump command processing, during the processing of a first block command of the first command block the current processing status of this interrupted first command block and the final address to be stored for the backjump from the second command block, resulting from the jump address and the number of commands of the second block command, are deposited in a local stack of the program control.

11. Method according to claim 7, wherein in the event of occurrence of a second block command, additionally to the jump command processing, during the processing of a first block command of the first command block the current processing status of this interrupted first command block and the final address to be stored for the backjump from the second command block, resulting from the jump address and the number of commands of the second block command, are deposited in a local stack of the program control.

12. Method according to claim 8, wherein in the event of occurrence of a second block command, additionally to the jump command processing, during the processing of a first block command of the first command block the current processing status of this interrupted first command block and the final address to be stored for the backjump from the second command block, resulting from the jump address and the number of commands of the second block command, are deposited in a local stack of the program control.

13. Method according to claim 9, wherein in the event of occurrence of a second block command, additionally to the jump command processing, during the processing of a first block command of the first command block the current processing status of this interrupted first command block and the final address to be stored for the backjump from the second command block, resulting from the jump address and the number of commands of the second block command, are deposited in a local stack of the program control.

14. Method according to claim 6 wherein the addresses of the commands compiled in the current command block are deposited in the special address area readable by the compiler.
